(19) United States
(12) Patent Application Publication
(10) Pub. No.: US 2023/0399494 A1
(43) Pub. Date: Dec. 14, 2023

(54) COMPOSITION COMPRISING A HIGHLY SUBSTITUTED HYDROXYPROPYL METHYLCELLULOSE AND A SUGAR ALCOHOL

(71) Applicant: NUTRITION & BIOSCINCES USA 1, LLC, Rochester, PA (US)

(72) Inventors: Kevin O'Donnell, Midland, MI (US); Rebecca Putans, Midland, MI (US); Oliver Petermann, Bomlitz (DE); Roland Bayer, Bomlitz (DE); Rene Kelling, Bomlitz (DE); Wesley Spaulding, Midland, MI (US)

(21) Appl. No.: 17/783,921

(22) PCT Filed: Dec. 7, 2020
(86) PCT No.: PCT/US2020/063564

§ 371 Date: Jun. 9, 2022

Related U.S. Application Data
(60) Provisional application No. 62/945,324, filed on Dec. 9, 2019.

(51) Int. Cl. C08L 1/28; B29C 48/27

(52) U.S. Cl. CPC C08L 1/284; B29C 48/27; C08L 2205/06

(57) ABSTRACT

A composition comprises a mixture of a hydroxypropyl methylcellulose having a DS of from 1.0 to 2.7 and an MS of from 0.40 to 1.30, wherein the sum of the DS and MS is from 1.8 to 3.6, and wherein DS is the degree of substitution of methoxyl groups and MS is the molar substitution of hydroxypropoxyl groups, and a sugar alcohol in a weight ratio of hydroxypropyl methylcellulose to sugar alcohol of from 98:2 to 85:15. The composition may for instance be used to purge extrusion equipment.

### FIELD OF INVENTION

The present invention relates to a composition comprising a highly substituted hydroxypropyl methylcellulose and a sugar alcohol, a process for reducing the tackiness of highly substituted hydroxypropyl methylcellulose during hot melt extrusion and a process for purging extrusion equipment of contaminant material adhered to interior surfaces thereof, by means of said composition.

### BACKGROUND OF THE INVENTION

Hydroxypropyl methylcellulose is a cellulose ether frequently used to prepare pharmaceutical formulations, such as amorphous solid dispersions, of poorly soluble drugs. G. Van den Mooter, “The use of amorphous solid dispersions: A formulation strategy to overcome poor solubility and dissolution rate”, Drug Discov Today: Technol (2011), doi:10.1016/j.ddtec.2011.10.002, discusses the preparation of amorphous solid dispersions to increase the bioavailability of poorly soluble drugs by improving their rate and extent of dissolution. The two most applied manufacturing methods for preparing amorphous solid dispersions appear to be spray drying and hot melt extrusion. In the most common setup of hot melt extrusion a powder blend is introduced via a feeder into a heated barrel with rotating screws, where the powder blend is heated and intensely mixed in the softened or partially or completely melted state and moved towards a die that shapes the melt as strands, films, pellets, tablets or capsules. The amount of heat and shear forces applied, as well as the rate of cooling when the extrudate leaves the die contributes to the physical structure of the solid dispersion. An amorphous solid dispersion is produced when the drug is present in a substantially amorphous, non-crystalline state.

European Patent Application EP 0 872 233 discloses a solid dispersion comprising (a) loviride and (b) one or more pharmaceutically acceptable water-soluble polymers. Among the large variety of listed water-soluble polymers hydroxypropyl methyl cellulose (HPMC) is said to be preferred, particularly HPMC 2910 which has about 29 weight percent of methoxyl groups and about 10 weight percent of hydroxypropoxyl groups.

When a polymeric material is subjected to extrusion, in particular hot melt extrusion, it softens into a flowable mass that is conveyed through the extruder barrel by means of screws. There is a tendency that some of the extruded material remains in the extrusion equipment as contaminants that are stuck on interior surfaces or in void spaces (e.g. screw flights) of the extrusion equipment and require cleaning of the equipment before a new batch of polymeric material is processed in the extruder so as to avoid incorporation of the containing material in the fresh polymer, which may lead to contamination of subsequent batches, poor appearance and/or properties thereof. One way of dealing with the problem is to disassemble the equipment and remove the contaminant material from the components thereof either by physical means, such as with a brush, or by applying a liquid cleaning solution, or both. Such a procedure is very time-consuming and efforts have been made more recently to develop purging compositions that can be processed through the extruder and remove the contaminants without necessitating disassembly of the equipment, or making disassembly more simple with reduced exposure hazards.

Prior to this invention, formulators have typically used some method of purging but have relied on the neat polymer that is the base of their formulation which may be very sticky and/or difficult to process. Other products exist for pharmaceutical production but they have a limited operating range or settings in which they can be used. For example, HME Cleaner Plus (GMP) from Biogrund comprises HPMC, MC, propylene glycol and colloidal silica; it is stated to be effective from 160-200° C. in the product literature. Below this range it is sticky and above it catastrophically degrades.

US 2014/0142018 discloses a purging composition for cleaning extruders and injection molding machines that comprises a cellulose ether and a solvent which is a polyhydric alcohol, such as a glycol, or an ether or ester thereof, or ethanolamine. The purging composition is prepared by heating and melting the cellulose ether in the solvent and cooling the solution until it solidifies. The cellulose ether may for instance be hydroxypropyl methylcellulose, hydroxyethyl methylcellulose or hydroxypropyl methylcellulose acetate succinate. Purging is performed above the melting temperature of the contaminant.

WO 2011/056459 discloses a method for cleaning the interior of polymer processing equipment where a contaminant material is adhered to the interior of the processing equipment. The purging composition used to clean the processing equipment comprises starch, water and a polyol plasticizer. When the purging composition is conveyed through the processing equipment, is removes residual polymer and contaminants adhered to interior surfaces.

WO 2014/014752 discloses a solid dispersion comprising a highly substituted grade of hydroxypropyl methylcellulose which has been found to have beneficial properties for preparing solid dispersions by hot melt extrusion. On the other hand, when the highly substituted grade of hydroxypropyl methylcellulose is being processed (mixed, kneaded or extruded) in a “plastic” state above the glass transition temperature (Tg) as in hot melt extrusion, the plastic mass shows a high stickiness and tackiness. The increased tackiness of the plastic mass has the disadvantage that it requires great efforts to clean the processing equipment such as extruders or mixers.

### SUMMARY OF THE INVENTION

It is an object of the invention to provide a composition comprising a highly substituted hydroxypropyl methylcellulose, which is significantly less tacky and sticky during hot melt extrusion than pure hydroxypropyl methylcellulose and therefore useful for preparing solid dosage forms with reduced loss of extruded mass due to adhesion of the composition to extrusion equipment and tableting tools.

It is further an object of the invention to provide a composition which can be used to purge extrusion equipment of contaminants adhered to the interior of the equipment. The present invention has the advantages of a significantly broader thermal processing window without resulting in any significant stickiness or catastrophic degradation, ability to purge a greater variety of formulations (due to higher melt viscosity), GMP for use in manufacturing settings, not including chemical scrubbing agents (i.e. environmentally friendly).

It has surprisingly been found that both objects can be achieved by adding a certain quantity of a sugar alcohol to a highly substituted hydroxypropyl methylcellulose before extrusion.

Thus, in one aspect, the invention relates to a composition comprising a mixture of a hydroxypropyl methylcellulose having a DS of from 1.0 to 2.7 and an MS of from 0.40 to 1.30, wherein the sum of the DS and MS is from 1.8 to 3.6, and wherein DS is the degree of substitution of methoxyl groups and MS is the molar substitution of hydroxypropoxyl groups, and a sugar alcohol in a weight ratio of hydroxypropyl methylcellulose to sugar alcohol of from 98:2 to 85:15.

In another aspect, the invention relates to process for producing said composition comprising blending the hydroxypropyl methylcellulose in the form of dry particles with an aqueous solution of the sugar alcohol and drying the resulting wet blend to a moisture content of less than 8% by weight.

In yet another aspect, the invention relates to a process for reducing the tackiness of a highly substituted hydroxypropyl methylcellulose during hot melt extrusion, the process comprising the steps of
a) blending a hydroxypropyl methylcellulose having a DS of from 1.0 to 2.7 and an MS of from 0.40 to 1.30, wherein the sum of the DS and MS is from 1.8 to 3.6, and wherein DS is the degree of substitution of methoxyl groups and MS is the molar substitution of hydroxypropoxyl groups, and a sugar alcohol in a weight ratio of hydroxypropyl methylcellulose to sugar alcohol of from 98:2 to 85:15, and optionally an active ingredient,
b) optionally kneading the blend of step a) at a temperature of from 95° C. to 230° C.,
c) subjecting the blend of step b) to extrusion at a temperature of from 95° C. to 230° C., and
d) recovering the extruded mass from the extruder.

In a further aspect, the invention relates to a process for purging extrusion equipment of a contaminant material adhered to interior surfaces of said equipment, the process comprising
a) charging the extrusion equipment with a purging composition comprising a mixture of a hydroxypropyl methylcellulose having a DS of from 1.0 to 2.7 and an MS of from 0.40 to 1.30, wherein the sum of the DS and MS is from 1.8 to 3.6, and wherein DS is the degree of substitution of methoxyl groups and MS is the molar substitution of hydroxypropoxyl groups, and a sugar alcohol in a weight ratio of hydroxypropyl methylcellulose to sugar alcohol of from 98:2 to 85:15,
b) conveying the purging composition through the extrusion equipment, and
c) removing the purging composition from the extrusion equipment, whereby substantially all the contaminant material adhered to an interior surface of the extrusion equipment is removed.

In a still further aspect, the invention relates to the use of a composition comprising a mixture of a hydroxypropyl methylcellulose having a DS of from 1.0 to 2.7 and an MS of from 0.40 to 1.30, wherein the sum of the DS and MS is from 1.8 to 3.2, and wherein DS is the degree of substitution of methoxyl groups and MS is the molar substitution of hydroxypropoxyl groups, and a sugar alcohol in a weight ratio of hydroxypropyl methylcellulose to sugar alcohol of from 98:2 to 85:15 for purging extrusion equipment of a contaminant material adhered to an interior surface of said equipment.

### BRIEF DESCRIPTION OF THE DRAWINGS

FIG. 1 is a photograph showing the screws of a Leistriz Nano 16 hot melt extruder following extrusion of HS HPMC without purging.

FIG. 2 is a photograph showing the screws of a Leistriz Nano 16 hot melt extruder following purging with HS HPMC and xylitol in a ratio of 95:5.

FIG. 3 is a photograph showing the screws of a Leistriz Nano 16 hot melt extruder following purging with HS HPMC and xylitol in a ratio of 90:10.

FIG. 4 is a photograph showing the screws of a Leistriz Nano 16 hot melt extruder following extrusion of copovidone and purging with HS HPMC and PEG 4000 in a ratio of 90:10.

FIG. 5 is a photograph showing the screws of a Leistriz Nano 16 hot melt extruder following extrusion of copovidone and purging with HS HPMC and xylitol in a ratio of 90:10.

FIG. 6 is a photograph showing the screws of a Leistriz Nano 16 hot melt extruder following extrusion of copovidone and purging with HS HPMC and sorbitol in a ratio of 90:10.

FIG. 7 is a photograph showing the screws of a Leistriz Nano 16 hot melt extruder following extrusion of HPMC 2910 and xylitol in a ratio of 90:10.

FIG. 8 is an image of a melting peak of xylitol obtained by differential scanning calorimetry of a dry blend of HS HPMC and xylitol in a ratio of 9:1.

FIG. 9 is an image of melting peaks of xylitol obtained by differential scanning calorimetry of a wet blend of HS HPMC and xylitol in a ratio of 9:1 prepared in a ring layer mixer.

FIG. 10 is a graph showing the results of thermal gravimetric analysis in terms of weight loss of xylitol alone, HS HMPC alone, and samples of the composition of the invention prepared in a ring layer mixer with different concentrations of xylitol in the aqueous xylitol solutions.

### DETAILED DESCRIPTION OF THE INVENTION

The composition of the present invention comprises a hydroxypropyl methylcellulose. It has a cellulose backbone having (3-1,4 glycosidically bound D-glucopyranose repeating units, designated as anhydroglucose units in the context of this invention, which are represented for unsubstituted cellulose by the formula

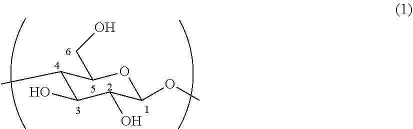

illustrating the numbering of the carbon atoms in the anhydroglucose units. The numbering of the carbon atoms in the anhydroglucose units is referred to in order to designate the position of substituents covalently bound to the respective carbon atom. At least a part of the hydroxyl groups of the cellulose backbone at the 2-, 3- and 6-positions of the anhydroglucose units are substituted by a combination of methoxyl and hydroxypropoxyl groups. The hydroxyl groups of the cellulose backbone at the 2-, 3- and 6-positions of the anhydroglucose units are not substituted by any groups other than methoxyl and hydroxypropoxyl groups.

The average number of methoxyl groups per anhydroglucose unit is designated as the degree of substitution of methoxyl groups, DS. In the definition of DS, the term “hydroxyl groups substituted by methoxyl groups” is to be construed within the present invention to include not only methylated hydroxyl groups directly bound to the carbon atoms of the cellulose backbone, but also methylated hydroxyl groups of hydroxypropoxyl substituents bound to the cellulose backbone.

The degree of the substitution of hydroxyl groups at the 2-, 3- and 6-positions of the anhydroglucose units by hydroxypropoxyl groups is expressed by the molar substitution of hydroxypropoxyl groups, the MS. The MS is the average number of moles of hydroxypropoxyl groups per anhydroglucose unit in the hydroxypropyl methylcellulose. It is to be understood that during the hydroxypropoxylation reaction the hydroxyl group of a hydroxypropoxyl group bound to the cellulose backbone can be further etherified by a methylation agent and/or a hydroxypropylation agent. The term “hydroxypropoxyl groups” thus has to be interpreted in the context of the MS as referring to the hydroxypropoxyl groups as the constituting units of hydroxypropoxyl substituents, which either comprise a single hydroxypropoxyl group or a side chain, wherein two or more hydroxypropoxyl units are covalently bound to each other by ether bonding. Within this definition it is not important whether the terminal hydroxyl group of a hydroxypropoxyl substituent is further methylated or not; both methylated and non-methylated hydroxypropoxyl substituents are included for the determination of MS.

The hydroxypropyl methylcellulose utilized in the composition of the present invention has a DS of from 1.0 to 2.7 and an MS of from 0.40 to 1.30. Preferably the hydroxypropyl methylcellulose has a DS of from 1.0 to 2.5, more preferably of from 1.1 to 2.3 and most preferably of from 1.6 to 2.3. Preferably the hydroxypropyl methylcellulose has an MS of from 0.50 to 1.30, more preferably from 0.60 to 1.20. Any preferred range for DS can be combined with any preferred range for MS. Most preferably the hydroxypropyl methylcellulose has a DS of from 1.6 to 2.3 and an MS of from 0.60 to 1.30. The sum of the DS and MS preferably is at least 1.8, more preferably at least 1.9, most preferable at least 2.5 and preferably up to 3.6, more preferably up to 3.40, most preferably up to 3.2.

This highly substituted hydroxypropyl methylcellulose has been found to be particularly useful for hot melt extrusion and is referred to in the following as “HS HPMC”. HS HPMC utilized in the present invention is described in U.S. Pat. No. 4,614,545 and WO 2014/014752.

The degree of substitution of methoxyl groups (DS) and the molar substitution of hydroxypropyl groups (MS) can be determined by Zeisel cleavage of the HS HPMC with hydrogen iodide and subsequent quantitative gas chromatographic analysis (G. Bartelmus and R. Ketterer, Z. Anal. Chem., 286 (1977) 161-190). The determination of the % methoxyl and % hydroxypropoxyl is carried out according to the United States Pharmacopeia (USP 35, “Hypromellose”, pages 3467-3469). The values obtained are methoxyl and % hydroxypropoxyl. These are subsequently converted into degree of substitution (DS) for methyoxyl substituents and molar substitution (MS) for hydroxypropoxyl substituents. Residual amounts of salt have been taken into account in the conversion.

The HS HPMC utilized in the composition of the present invention can be in a wide viscosity range. Typically, it is in a range from 5 to 150,000 mPa·s, measured as a 2 weight-% solution in water at 20° C. according to USP 35, “Hypromellose”, pages 3467-3469. It has been found that compositions of the present invention can be prepared by extrusion, typically melt-extrusion, over a wide viscosity range of the HS HPMC. The composition may also be prepared using a HS HPMC with a low viscosity of from 1.2 to 500 mPa·s, preferably from 1.2 to 200 mPa·s, and in particular from 2.4 to 120 mPa·s, measured as a 2 weight-% solution in water at 20° C. HS HPMC of such viscosity can be obtained by subjecting HS HPMC of higher viscosity to a partial depolymerization process. Partial depolymerization processes are well known in the art and described, for example, in European Patent Applications EP 1,141,029; EP 210,917; EP 1,423,433; and U.S. Pat. No. 4,316,982.

The present composition comprises, as a second component, a sugar alcohol in a weight ratio of HS HPMC to sugar alcohol of from 98:2 to 85:15. Preferably, the weight ratio of HS HPMC to sugar alcohol is from 95:5 to 90:10. The sugar alcohol may be selected from the group consisting of xylitol, sorbitol, mannitol, maltitol, erythritol, glycerol, arabitol, ribitol, galactitol, fucitol, inositol and lactitol, and mixtures thereof, but is preferably xylitol or sorbitol, most preferably xylitol.

The composition of the present invention may be used to prepare a solid dispersion of one or more active ingredients, most preferably one or more drugs. The term “drug” is conventional, denoting a compound having beneficial prophylactic and/or therapeutic properties when administered to an animal, especially humans. Preferably, the drug is a poorly soluble drug, meaning that the drug has an aqueous solubility at physiologically relevant pH (e.g., pH 1-8) of about 0.5 mg/mL or less. The invention finds greater utility as the aqueous solubility of the drug decreases. Thus, compositions of the present invention are preferred for low-solubility drugs having an aqueous solubility of less than 0.1 mg/mL or less than 0.05 mg/mL or less than 0.02 mg/mL, or even less than 0.01 mg/mL where the aqueous solubility (mg/mL) is the value observed in any physiologically relevant aqueous solution (e.g., those with pH values between 1 and 8) including USP simulated gastric and intestinal buffers. Examples of low-solubility drugs are for instance those disclosed in WO 2005/115330, page 17-22.

According to one aspect of the invention, the present composition is prepared by mixing HS HPMC as defined above, one or more sugar alcohols and optionally one or more active ingredients and subjecting the mixture to extrusion. The term “extrusion” as used herein includes processes known as ram extrusion, hot melt extrusion, injection molding, fusion processing or filament production. Techniques for extruding compositions comprising an active ingredient such as a drug are known and described by Joerg Breitenbach, Melt extrusion: from process to drug delivery technology, European Journal of Pharmaceutics and Biopharmaceutics 54 (2002) 107-117, or in European Patent Application EP 0 872 233. In one embodiment, the HS HPMC, sugar alcohol(s) and optionally active ingredient(s) may be mixed in the form of particles, preferably in powdered form. The HS HPMC, sugar alcohol(s) and optionally active ingredient(s) may be pre-mixed before feeding the mixture into a device utilized for extrusion, preferably hot melt extrusion. Useful devices for extrusion, specifically useful extruders, are known in the art. Alternatively, the HS HPMC, sugar alcohol(s) and optionally active ingredient(s) may be fed separately into the extruder and blended in the device before or during a heating step.

Preferably HS HPMC, sugar alcohol(s) and optionally active ingredient(s) are pre-blended in a mixer and fed from there into the extruder. In the present context, the term “pre-blended in a mixer” is intended to encompass methods such as melt granulation, dry blending supported by co-milling, dry blending supported by acoustic mixing, wet blending by high shear granulation, wet blending in a ring layer mixer, kneading and any other way of providing a mixture of HS HPMC, sugar alcohol(s) and optionally active ingredient(s) before extrusion thereof.

In a currently preferred embodiment, HS HPMC in the form of dry particles is blended with an aqueous solution of the sugar alcohol(s) and the resulting wet blend is dried to a moisture content of less than 8% by weight. The aqueous solution of the sugar alcohol(s) is preferably blended with the HS HPMC by spraying the solution onto the HS HPMC in a mixer such as a ring layer mixer or granulator. The wet blend may preferably be dried, e.g. in a fluidized bed dryer, to a moisture content of less than 5% by weight, or even less than 1% by weight.

A ring layer mixing process useful for pre-blending HS HPMC, sugar alcohol(s) and optionally active ingredient(s) may comprise the following steps:
the sugar alcohol is dissolved in an aqueous liquid;
dry particles of HS HPMC and optionally active ingredient(s) are conveyed into the ring layer mixer with a screw conveyor at a defined rate;
a rapidly rotating agitator moves the HS HPMC particles to an interior surface of a tube in the ring layer mixer to form a ring layer moving from an inlet to an outlet of the ring layer mixer,
the aqueous solution of sugar alcohol(s) is pumped into the ring layer mixer so that the solution is homogenously sprayed on the HS HPMC particles;
the wet blend of HS HPMC, sugar alcohol(s) and optionally active ingredient(s) is collected at the outlet of the ring layer mixer; and
the wet blend is dried, e.g. in a fluidized bed dryer.

Pre-blending HS HPMC, sugar alcohol(s) and optionally active ingredient(s) in a granulator may comprise the following steps:
the sugar alcohol is dissolved in an aqueous liquid;
the HS HPMC is charged into the mixing bowl of a granulator such as a high shear wet granulator;
the granulator is started such that internal mixing elements, for example horizontal agitators and vertical impellers, begin agitation and movement of the powder HS HPMC;
the aqueous solution of sugar alcohol is sprayed at a controlled rate onto the agitated HS HPMC until the amount of sugar alcohol applied reaches a determined w/w % ratio with respect to the finished dried composition;
the resulting wet mass is removed from the granulator and optionally subjected to wet milling;
the wet mass is dried by means of static or fluid drying methods including, but not limited to, tray drying, vacuum drying, oven drying, or fluidized bed drying;

The dried mass is then optionally subjected to dry milling to the final desired particle size.

The aqueous liquid in which the sugar alcohol is dissolved may be either water alone or water mixed with a minor amount of an organic solvent. The aqueous liquid preferably consists of 50-100% by weight, more preferably 75-100% by weight of water and preferably 0-50% by weight, more preferably 0-25% by weight, of an organic solvent based on the total weight of water and organic solvent. Preferred organic solvents are alcohols such as methanol, ethanol, isopropanol or n-propanol, ethers such as tetrahydrofuran, ketones such as acetone, methyl ethyl ketone or methyl isobutyl ketone, acetates such as ethyl acetate, halogenated hydrocarbons such as methylene chloride or nitriles such as acetonitrile. The aqueous liquid preferably comprises water alone as the solvent.

The composition or the individual components thereof that has or have been fed into an extruder are passed through a heated area of the extruder at a temperature which will melt or soften the composition or at least one or more components thereof to form a mixture throughout which the components are homogenously dispersed. The mixture is subjected to extrusion and caused to exit the extruder. Typical extrusion temperatures are from 95 to 230° C., preferably from 100 to 200° C., more preferably from 110 to 190° C., as determined by the setting for the extruder heating zone(s). An operating temperature range should be selected that will minimize the degradation or decomposition of the active ingredient and other components of the composition during processing. Single or multiple screw extruders, preferably twin screw extruders, can be used in the extrusion process of the present invention. The molten or softened mixture obtained in the extruder is forced through one or more exit openings, such as one or more nozzles or dies. The molten or softened mixture then exits via a die or other such element having one or a plurality of openings, at which time, the extruded blend (now called the extrudate) begins to harden. Since the extrudate is still in a softened state upon exiting the die, it may be easily shaped, molded, chopped, spheronized into beads, cut into strands, tableted or otherwise processed to the desired physical form. Additionally, the extrudate can be cooled to hardening and ground to a powdered form.

It has surprisingly been found that when a sugar alcohol is added to the HS HPMC in a weight ratio of HS HPMC to sugar alcohol of from 98:2 to 85:15, the tackiness of the molten or softened mixture is dramatically decreased, and the composition may be transferred from the mixer and through the extruder with hardly any residue sticking to the walls or tools of the extrusion equipment, and also permits less resource demanding cleaning of the extrusion equipment. Furthermore, the molten or softened mixture exiting the die may be subjected to processing such as tableting without significantly sticking to the processing tools such as the tableting machine.

In the process for purging extrusion equipment, the purging composition passes through the extrusion equipment and is removed together with substantially all of the contaminant material adhered to interior surfaces of the equipment.

In the present context, the term “extrusion equipment” is to be understood broadly as any equipment or component thereof that is used at some stage of the extrusion process, including, but not limited to, ram extrusion, hot melt extrusion, injection molding, thermal fusion and filament production, and including any components that are exposed to the polymeric or other material being extruded such as kneaders, blenders, mixers, screws and interior surfaces of extruder barrels or tubes.

As evidenced in Examples 2-4 below, the present purging composition has been found to be far less adherent to metal surfaces of extrusion equipment than the highly substituted HPMC polymer alone when subjected to hot melt extrusion.

The temperature at which purging takes place is suitably from 95° C. to 230° C., preferably from 100° C. to 200° C. such as 110° C. to 190° C.

The contaminant material to be removed by purging with the present composition may be any material remaining in the extrusion equipment after use, e.g. residual extruded polymeric material, degradation products produced during extrusion or additives such as pigments, colorants, fillers, etc.

It has been found that unlike some of the purging compositions disclosed in the literature, the present composition can be made without adding water or an organic solvent, and the extrusion and/or purging process can be conducted in the absence of added water or organic solvent.

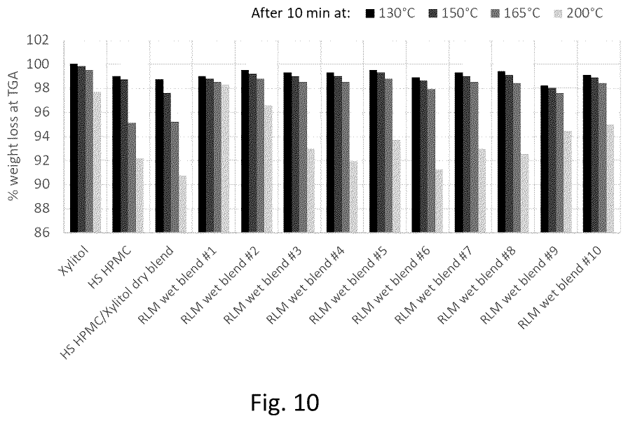

It has surprisingly been found, however, that when the purging composition is prepared by blending the HS HPMC in the form of dry particles with an aqueous solution of the sugar alcohol followed by drying the blend, the composition exhibits improved thermal stability determined as reduced weight loss at temperatures between 165° C. and 200° C. compared to a purging composition prepared from a dry blend of HS HPMC and sugar alcohol, cf. FIG. 10 and Example 5 below. Increased thermal stability of the present composition may be advantageous as it increases the operating range of the composition in the extruder and increases the working time. Increased thermal stability may also reduce risks associated with degradation such as formation of unknown impurities and off-gassing.

The invention is further described in the following examples.

### Materials and Methods

### Preparation of a Highly Substituted HPMC (HS HPMC)

2 kg ground cellulose are alkalized with 6.3 kg of 50% by weight aqueous sodium hydroxide at about 30° C. in a reaction vessel equipped with agitator, temperature controls and vacuum line.

The vessel is then evacuated and after evacuation 4.6 kg methyl chloride and 1.2 kg propylene oxide are added. The temperature in the vessel is subsequently increased from 30° C. to 90° C. After 8 hours the HPMC is washed with water at about 90° C. and recovered and dried to a powder with a median particle size DIFI₅₀/LEFI₅₀/EQPC₅₀ of 65/182/113, respectively, as determined by a QIPIC image analysis system, as discussed below.

The resulting HPMC has a methoxyl substitution of 28% and a hydroxypropoxyl substitution of 21%. The viscosity of a 2% by weight aqueous solution of the HPMC is mPa·s, measured using an Ubbelohde viscometer.

### Particle Size and Shape Using a QICPIC Image Analysis System

A Sympatec QICPIC image analyzer consists of a particle dispersing system, a laser and a high-speed camera (1024×1024) with max. frame rate of 500 frames/sec. Dispersed by a pressurized air system and a nozzle the particles are illuminated by the laser beam. The shade pictures of the particles are captured by the camera. Particle images on up to 40000 frames per measurement are translated into average particle properties by the WINDOX software. The properties used in this report are median properties, such that 50% of the particles are smaller than the stated size in μm:
EQPC (x₅₀=50%): Diameter of a circle having the same area as the projection area of the particle.
DIFI (x₅₀=50%): Diameter of a fiber is calculated by division of the projection area and the sum of the length of all branches of the projected fiber.
LEFI (x₅₀=50%): Length of a fiber is defined by the longest direct connection between its opposing ends.

### Measurement of Moisture Content

A Satorius MA150 moisture analyzer is used to measure the moisture content by loss on drying. The heating source is a ceramic IR heating element offering stable, consistent and fast heating of the 2 to 3 g sample. For the present compositions and wet blends, a temperature of 130° C. is used to evaporate the product moisture. The LOD is calculated by the following formula:

$$LOD = \frac{{Wt}_{( wet )} - {Wt}_{( dry )}}{{Wt}_{( wet )}} \times 100 \%$$

Modulated Differential Scanning Calorimetry (mDSC)

Samples were heated under nitrogen starting from 20° C. to 200° C. with 2° C./min and a modulation of 0.63° C./min followed by cooling down to 20° C. at a rate of 20° C./min using a TA Discovery DSC. The material was again heated from 20° C. to 200° C. with 2° C./min and a modulation of 0.63° C./min.

### Thermal Gravimetric Analysis (TGA)

The material was heated under air from 30° C. to 130° C. with a rate of 20° C./min. At 130° C. the temperature was maintained for 10 min (isothermal stage) followed by heating up to next isothermal stage of 150° C. (10 min), 165° C. (10 min), 200° C. (10 min) and finally to 300° C. with a rate of 20° C./min using a TA Discovery TGA.

### Example 1

### Thermoplastic Kneading Step:

The 30 ml kneading cell W30 of a Brabender Plasti-Corder PL 2000 torque kneader with metallic cover head was heated to a suitable temperature (see table below). After automatic calibration of the empty cell HS HPMC (Composition 1; C1 in the table) or a homogeneous mixture of HS HPMC and sorbitol were filled into the cell. With a closure head the homogenization was done at 30 rpm until a constant torque was reached.

### Extrusion Trials:

A capillary rheometer (Malvern RH10, Malvern Instruments), equipped with a die of a suitable diameter was heated up (for the temperature see table below) and filled with the paste coming out of the torque kneader trial. Vertical extrusion through the die was performed with a piston driving in the range of 10 mm/min.

| | | Kneading (^{Remark 1)} | | | | | |
|---|---|---|---|---|---|---|---|
| | | Temperature | Kneading | | | Extrusion (^{Remark 2)} | |
| | | a) (cell | tool | Torque (Nm) | Removal | Conditions | |
| | | empty, ° C.) | rotation | a) Max. (at | of | (Temperature | |
| Trial | Product | b) T (max during | speed | beginning) | material | (° C.)/, speed | Pressure |
| No | composition | kneading, ° C.) | (rpm) | b) at the end | from cell | (mm/min)) | (MPa) |
| C1 | 100% HS | a)134 | 30 | a) Not recorded | Sticky on | 143/10 | 17.9 (1 min) |
| | HPMC | b)148 | | b)11.6 | the | | 16.9 (3 min) |
| | | | | | kneading | | 16.7 (5 min) |
| | | | | | tools and | | |
| | | | | | in the | | |
| | | | | | mold | | |
| 2 | 95% HS | a) 175° C., | 30 | a) 8.5 Nm | Can be | 173/5 | 5.1 (1 min), |
| | HPMC, 44 | b) 183° C. | | b) 6.4 Nm | removed | | 5.4 (18 min) |
| | mPa · s, 5% | | | | in one | | |
| | sorbitol | | | | piece, | | |
| | | | | | not | | |
| | | | | | sticky at | | |
| | | | | | all | | |
| 3 | 98% HS | a) 134 | 30 | a) Not recorded | Can be | 143/10 | 17.9(1 min) |
| | HPMC, 2% | b) 149 | | b)11.6 | removed | | 16.9 (3 min) |
| | sorbitol | | | | in one | | 16.7 (5 min) |
| | | | | | piece, | | |
| | | | | | not | | |
| | | | | | sticky at | | |
| | | | | | all | | |
| 4 | 95% HS | a) 140 | 30 | a) 12.0 | Can be | 143/10 | 14.6 (1 and 3 |
| | HPMC, 5% | b) 149 | | b) 11.3 | removed | | min) |
| | sorbitol | | | | in one | | 14.5 (5 min) |
| | | | | | piece, | | |
| | | | | | not | | |
| | | | | | sticky at | | |
| | | | | | all | | |
| 5 | 95% HS | a) 141 | 30 | a) Not recorded | Can be | 143/10 | 15 (1 min) |
| | HPMC, | b) 152 | | b)9.8 | removed | | 14.3 (3 min) |
| | milled, 5% | | | | in one | | 14.4 (5 min) |
| | sorbitol | | | | piece, | | |
| | | | | | not | | |
| | | | | | sticky at | | |
| | | | | | all | | |

Remark 1: Kneading equipment: Brabender torque kneader, kneading cell: 30 ml.
Remark 2: Extrusion equipment: Malvern RH 10 capillary rheometer, utilized die: 1.7 mm diameter

It appears from the table above that Composition 1 containing HS HPMC and no sorbitol was sticky and could not be removed from the extrusion tool without leaving a residue, whereas the compositions 2-5 containing sorbitol in addition to HS HPMC could be removed in one piece and were not sticky.

### Example 2

### Sample Preparation

HS HPMC, prepared as described above, and xylitol (Xivia CM 90) were accurately weighed into a glass jar at the desired ratio (95:5, 9:1, 85:15), processed to eliminate xylitol aggregates, and blended in a Turbula blender for 5 minutes.

### Extrusion

Extrusion trials were conducted on a Leistritz Nano16 hot melt extruder. Temperatures of the feed and 4 heated zones were set to Water Cooled Feed, 150° C., 160° C., 165° C., 165° C. Die. Screw speed was set to 175 RPM. 60 grams of purging composition was added in each case. After each trial the screws and barrel were cleaned as necessary to ensure a clean system for the subsequent run.

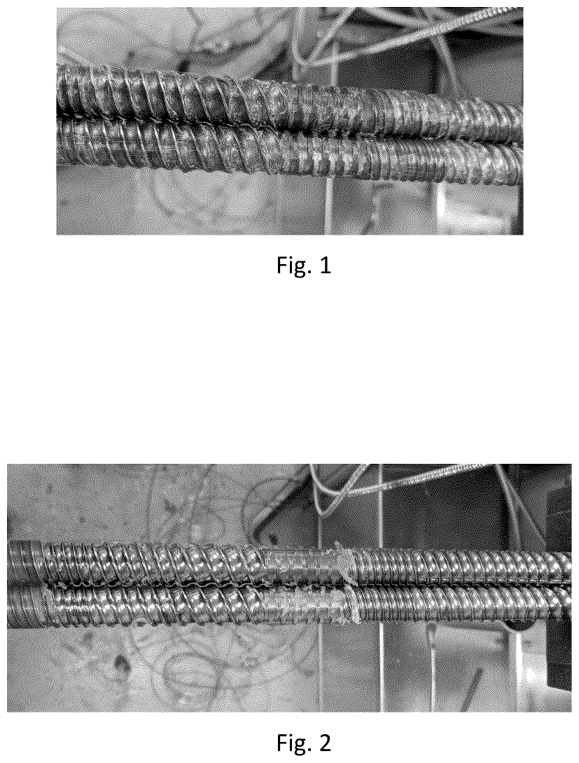

A first trial was performed with HS HPMC alone. This resulted in significant material remaining on the screws and the screws being very difficult to remove from the extruder (FIG. 1).

A second trial included 95:5 HS HPMC:xylitol and resulted in significantly less material remaining on the screws (FIG. 2). The screws required minimal force for removal.

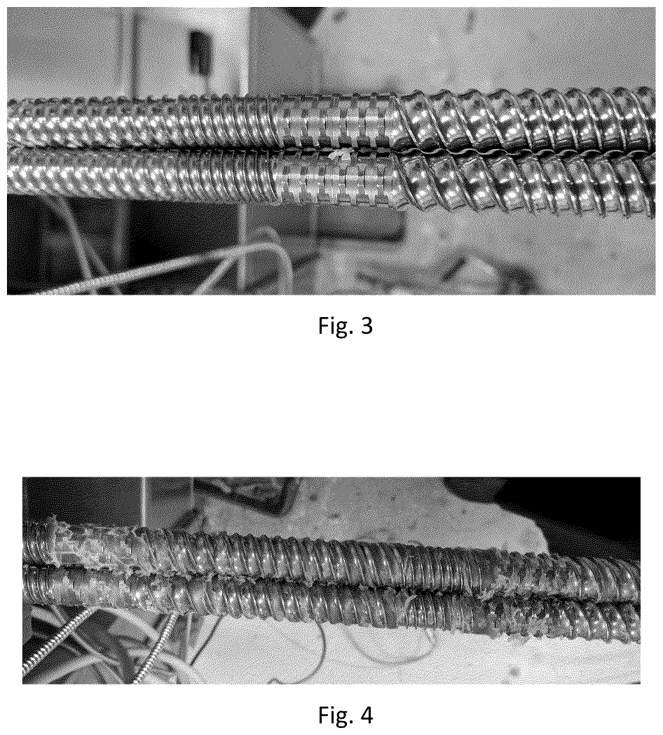

A third trial comprised 90:10 HS HPMC:Xylitol. This formulation resulted in almost no material remaining on the screws or barrel wall and required no force to remove the screws from the extruder (FIG. 3).

This also resulted in a clean die assembly; the material that remained in the die block detached easily and could be removed by hand (image not shown).

Increasing the xylitol content to 15% also resulted in clean screws (image not shown).

### Example 3: Comparison with Alternative Additives

### Sample Preparation

HS HPMC, prepared as described above, was blended at a 90:10 ratio with either xylitol, sorbitol, or polyethylene glycol 4000 in a Turbula blender for 5 minutes. If needed, the additive was first sieved to eliminate lumps.

### Hot Melt Extrusion

All trials were conducted on a Leistritz Nano16 hot melt extruder. Prior to introduction of the purging composition 30 grams of copovidone was manually fed into the extruder to simulate a formulation being processed. 60 grams of the purging composition was then introduced, and the screws were removed for imaging after the composition had finished exiting.

### Results

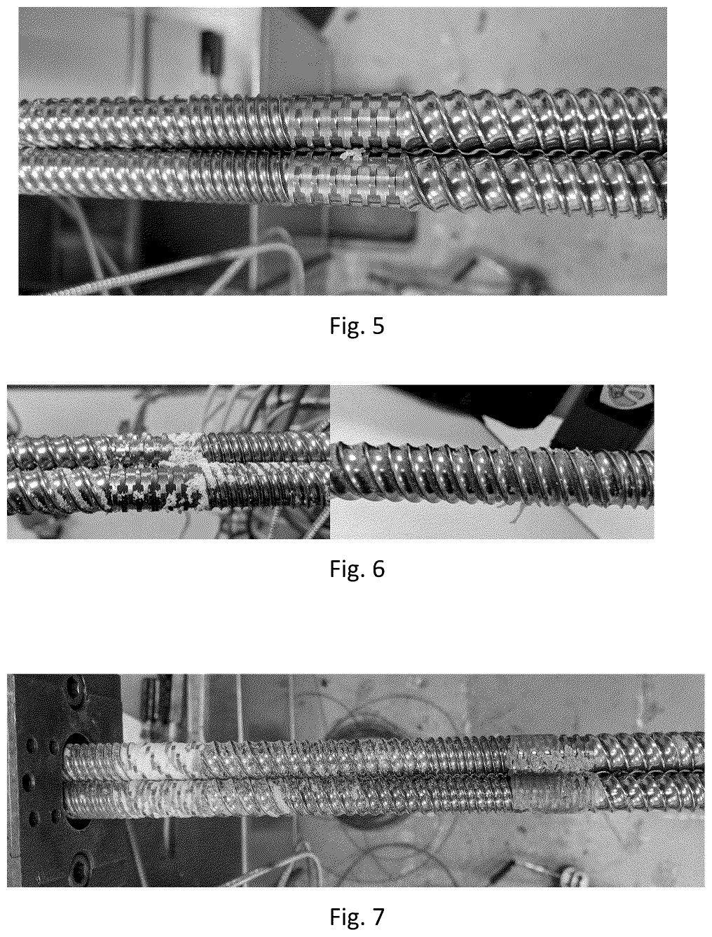

The composition comprising PEG 4000 resulted in significant material remaining on the screws (FIG. 4) and moderate difficulty removing the screws. No apparent copovidone remained. The composition comprising xylitol resulted in a clean screw with no apparent copovidone remaining (FIG. 5) and simple screw removal. The composition comprising sorbitol resulted in some residual material on the screws, especially the leading flight but did have simple screw removal (FIG. 6).

### Example 4: Comparison with Alternative HPMC Substitution

### Sample Preparation

HPMC type 2910 (available from DuPont) with a 2% aqueous solution viscosity of either 5 mPa·s or 50 mPa·s was blended at a 90:10 ratio with xylitol by first removing xylitol lumps via sieving, manually blending in the HPMC and then further blending in a Turbula blender for 5 minutes.

### Hot Melt Extrusion

All trials were conducted on a Leistritz Nano16 hot melt extruder. Temperatures of the heated zones were set to 150° C., 160° C., 165° C., and 165° C. Screw speed was set to 175 RPM. 100 grams of the blend was introduced into the feed throat, and the screw speed was increased to 250 RPM once no material remained in the throat. The screws were removed for imaging after the composition had finished exiting.

### Results

The blend containing the 50 mPa·s HPMC 2910 could not be processed; upon introduction, the torque exceeded the maximum value deliverable by the motor causing seizing. The blend containing the 5 mPa·s HPMC 2910 successfully processed but with very high pressure (˜1500 PSI vs ˜300 PSI when processing HS HPMC) and torque. Following completion of the run the screws were removed and a moderate amount of residual material was visible (FIG. 7). The material remaining became physically hard after only slightly cooling; all material remaining on the screws could be removed without significant difficulty using a wire wheel. However, the blend did not pull clean of the die block and the material remaining in the die was extremely hard and extremely difficult to clean out.

### Example 5

### Sample Preparation

Highly substituted HPMC prepared as described above and xylitol were blended in a ring layer mixer (RLM; Corimix CM 20 available from Loedige, Germany) at different process conditions. In a first step aqueous xylitol solutions with different concentrations were prepared (35%, 45% and 60% by weight). The HS HPMC was added at different dosage rates (25 kg/h and 50 kg/h) via a screw conveyor into the RLM where a ring layer was formed due to the high rotational speed of more than 2000 rpm. The xylitol solutions were sprayed on the moving ring layer via a number of nozzles distributed along the rotating shaft of the RLM. The residence time in the RLM was between 10 and 20 seconds. The solutions were added at different dosage rates to obtain a blend with a target xylitol concentration after water removal of 9%-11% by weight. 20 kg blends were produced at each of the ten different settings. The process conditions are summarized in Table 2 below

TABLE 2

| | \dot{M}ₛₒₗ target | \dot{M}_{liq} target | C_{xylitol} | RPM_{RLM} | LOD_{actual} |
|---|---|---|---|---|---|
| | Kg/h | Kg/h | % | % | % |
| # | 25 | 7.8 | 35 | 70 | 13.9 |
| | 50 | 16.1 | 35 | 70 | 14.4 |
| | 25.4 | 6.2 | 45 | 70 | 10.9 |
| | 50.7 | 12.3 | 45 | 70 | 11.2 |
| | 25.4 | 6.2 | 45 | 40 | 10.9 |
| | 25.4 | 4.6 | 60 | 70 | 7.0 |
| | 50.7 | 9.3 | 60 | 70 | 6.9 |
| | 25.4 | 3.0 | 60 | 70 | 4.9 |
| | 25.4 | 7.9 | 35 | 70 | 15.5 |
| | 50.7 | 15.9 | 35 | 70 | 16.3 |

The wet blends with a water content between 10 and 20% by weight were dried afterwards in a standard fluidized bed dryer at inlet temperatures of not more than 50° C. and actual product temperatures of approximately 40° C. to a moisture content of less than 1% by weight.

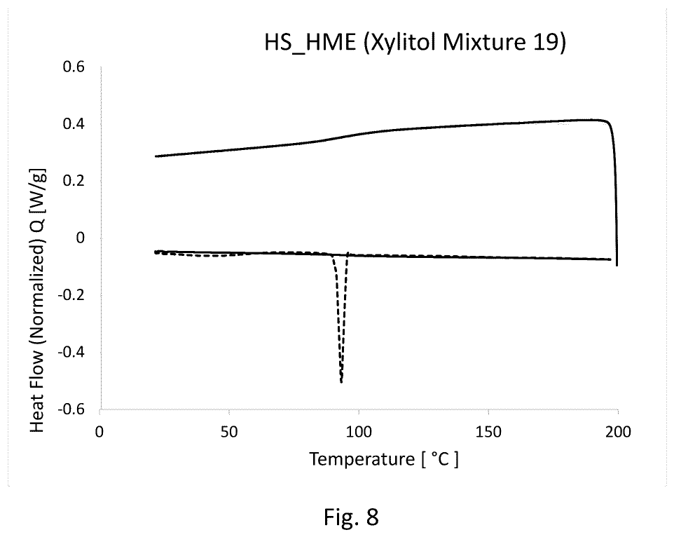

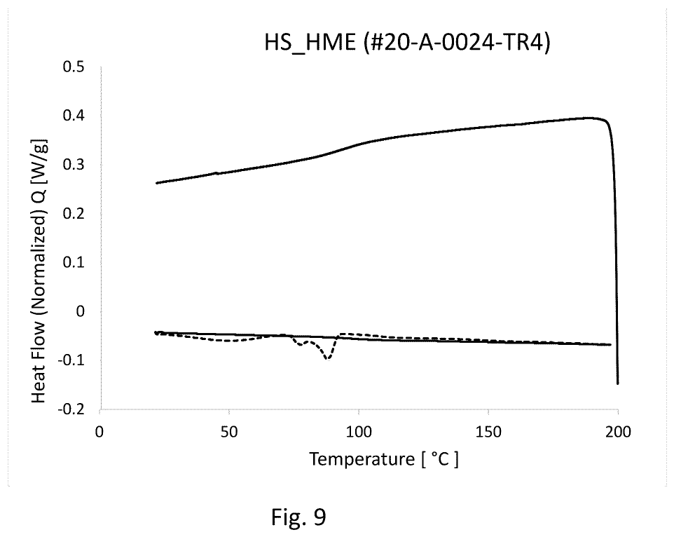

Significant differences were observed for the RLM blends and the dry blend of HS HPMC and xylitol (9:1) which served as a reference. The dry blend showed a strong and sharp xylitol melting peak at 91° C. in the first heating curve (FIG. 8) which indicated that xylitol did not form a molecular blend with the HS HPMC. In the second heating curve no melting peak was observed indicating a molecular blend now which was formed when xylitol melted during the first heating cycle. The RLM blends showed two broad weak xylitol melting peaks at 74 and 82° C. in the first heating curve (FIG. 9) indicating that partially a molecular blend was formed in the ring layer mixer. The double peak and the decrease in melting point temperature indicates that xylitol might have partially crystallized into a different crystalline form during the drying of the blends. The second heating curve no longer showed a xylitol peak indicating the formation of a complete molecular blend.

Thermal gravimetric analysis showed improved thermal stability for the RLM blends. Improved thermal stability was observed beginning at 165° C. and was most pronounced when the last isothermal stage of 200° C. was completed. At the end of the 200° C. isothermal stage the weight loss of the dry blend was about 9%, slightly more than the weight loss of the HS HPMC feedstock whereas the best RLM blend (#1) experienced a weight loss of only about 1.75% (FIG. 10). Weight loss at 150 and 165° C. did not differ to a great extent for the RLM blends in contrast to the weight loss at 200° C.

### Hot Melt Extrusion of RLM Samples

All trials were conducted on a Leistritz Nano16 hot melt extruder. Temperatures of the heated zones were set to 150° C., 160° C., 165° C., and 165° C. Screw speed was set to 175 RPM. Prior to introduction of the purging composition 30 grams of copovidone was manually fed into the extruder to simulate a formulation being processed. Subsequently, 60 grams of the purging composition was then introduced and processed to completion. The screws were removed for imaging after the composition had finished exiting.

### Results

All trials utilizing the RLM composition for purging resulted in a clean screw with no apparent copovidone remaining and simple screw removal.

### Example 6

### Sample Preparation

111 g of xylitol was dissolved in 200 g of water. 999 g of HS HPMC in dry powder form was charged into the mixing bowl of a Powrex Vertical Granulator, model FM-VG-0 and agitated at the following settings: main blade: 300 rpm and cross screw: 1500 rpm. The aqueous solution of xylitol (311.14 g) was sprayed onto the agitated HS HPMC at a spray rate of approximately 11.5 g/min to 12 g/min over a period of 26.16 min. The resulting wet mass was dried in an oven at 85° C. to approximately 1% moisture.

Thermal gravimetric analysis showed improved thermal stability of example 6. Improved thermal stability was observed at 165° C. At the end of the 165° C. isothermal stage the weight loss of the dry blend was 2.9%, whereas the weight loss of the HS HPMC feedstock was about 5%. The weight loss at 150° C. was 1.9% and the weight loss at 130° C. was 1.3%.

1. A composition comprising a mixture of a hydroxypropyl methylcellulose having a DS of from 1.0 to 2.7 and an MS of from 0.40 to 1.30, wherein the sum of the DS and MS is from 1.8 to 3.6, and wherein DS is the degree of substitution of methoxyl groups and MS is the molar substitution of hydroxypropoxyl groups, and a sugar alcohol in a weight ratio of hydroxypropyl methylcellulose to sugar alcohol of from 98:2 to 85:15.

2. The composition of claim 1, wherein said hydroxypropyl methylcellulose has a DS of from 1.0 to 2.5.

3. The composition of claim 1, wherein said at least one hydroxypropyl methylcellulose has a MS of from 0.50 to 1.30.

4. The composition of claim 1, wherein said hydroxypropyl methylcellulose has a DS of from 1.6 to 2.3 and an MS of from 0.60 to 1.30.

5. The composition of claim 1, wherein the weight ratio of said hydroxypropyl methylcellulose and sugar alcohol is from 95:5 to 90:10.

6. The composition of claim 1, wherein the sugar alcohol is selected from the group consisting of xylitol, sorbitol, mannitol, maltitol, erythritol, glycerol, arabitol, ribitol, galactitol, fucitol, inositol and lactitol, and mixtures thereof.

7. The composition of claim 6, wherein the sugar alcohol is xylitol or sorbitol.

8. The composition of claim 1, wherein the hydroxypropyl methylcellulose has a viscosity from 5 to 150,000 mPa·s as a 2% aqueous solution at 20° C.

9. The composition of claim 1, wherein the hydroxypropyl methylcellulose has a viscosity of from 1.2 to 500 mPa·s as a 2% aqueous solution at 20° C.

10. The composition of claim 1, which is a solid dispersion of an active ingredient in said mixture of hydroxypropyl methylcellulose and sugar alcohol.

11. A process for producing the composition of claim 1, comprising blending the hydroxypropyl methylcellulose in the form of dry particles with an aqueous solution of the sugar alcohol and drying the resulting wet blend to a moisture content of less than 8% by weight.

12. The process of claim 11, wherein the aqueous solution of the sugar alcohol is sprayed onto the hydroxypropyl methylcellulose in a ring layer mixer or granulator.

13. A process for reducing the tackiness of a highly substituted hydroxypropyl methylcellulose during hot melt extrusion, the process comprising the steps of
a) blending a hydroxypropyl methylcellulose having a DS of from 1.0 to 2.7 and an MS of from 0.40 to 1.30, wherein the sum of the DS and MS is from 1.8 to 3.6, and wherein DS is the degree of substitution of methoxyl groups and MS is the molar substitution of hydroxypropoxyl groups, and a sugar alcohol in a weight ratio of hydroxypropyl methylcellulose to sugar alcohol of from 98:2 to 85:15,
b) subjecting the blend of step b) to extrusion at a temperature of from 95° C. to 230° C., and
c) recovering the extruded mass from the extruder.

14. The process of claim 13, wherein the weight ratio of said hydroxypropyl methylcellulose to sugar alcohol is from 95:5 to 90:10.

15-16. (canceled)

17. The process of claim 13, wherein step (a) comprises blending the hydroxypropyl methylcellulose in the form of dry particles with an aqueous solution of the sugar alcohol and drying the resulting wet blend to a moisture content of less than 8% by weight.

18. The process of claim 17, wherein the aqueous solution of the sugar alcohol is sprayed onto the hydroxypropyl methylcellulose in a ring layer mixer or granulator.

19. A process for purging extrusion equipment of a contaminant material adhered to interior surfaces of said equipment, the process comprising
a) charging the extrusion equipment with a purging composition comprising a mixture of a hydroxypropyl methylcellulose having a DS of from 1.0 to 2.7 and an MS of from 0.40 to 1.30, wherein the sum of the DS and MS is from 1.8 to 3.6, and wherein DS is the degree of substitution of methoxyl groups and MS is the molar substitution of hydroxypropoxyl groups, and a sugar alcohol in a weight ratio of hydroxypropyl methylcellulose and sugar alcohol of from 98:2 to 85:15,
b) conveying the purging composition through the extrusion equipment, and
c) removing the purging composition from the extrusion equipment, whereby substantially all the contaminant material adhered to an interior surface of the extrusion equipment is removed.

20. The process of claim 19, wherein step b) is conducted at a temperature of from 95° C. to 230° C.

21-23. (canceled)

24. The process of claim 19, wherein step (a) comprises blending the hydroxypropyl methylcellulose in the form of dry particles with an aqueous solution of the sugar alcohol and drying the resulting wet blend to a moisture content of less than 8% by weight.

25. The process of claim 24, wherein the aqueous solution of the sugar alcohol is sprayed onto the hydroxypropyl methylcellulose in a ring layer mixer or granulator.

26. (canceled)
